(19) United States
(12) Patent Application Publication
(10) Pub. No.: US 2005/0121125 A1
(43) Pub. Date: Jun. 9, 2005

(54) Inflating and deflating valve for a wheel of a vehicle

(75) Inventor: Michel Maquaire, Ardon (FR)

Correspondence Address: OLIFF & BERRIDGE, PLC, P.O. BOX 19928, ALEXANDRIA, VA, 22320, US

(73) Assignee: SYEGON, VERSAILLES (FR)

(21) Appl. No.: 10/502,711

(22) PCT Filed: Jan. 22, 2003
(86) PCT No.: PCT/FR03/00215

(30) Foreign Application Priority Data
Jan. 29, 2002 (FR) 02/01058

(51) Int. Cl. B60C 23/10

(52) U.S. Cl. 152/415

(57) ABSTRACT

The invention relates to a wheel valve (1) for the tyre of a vehicle, comprising a non-return valve (11), two half-bodies (3,4) defining a cavity and assembled with a membrane (6) inserted therebetween acting as a sealing joint between said half-bodies, said non-return valve comprising a tubular element (12) which is connected to the membrane and inside which the closing element (18) can move between a seat (17) and a base (20), said closing element being applied against the seat by means of the pressure prevailing in the tyre. The closing element (18) is subjected to the action of a magnetic field ensuring the maintainance thereof at the base (20) so that the valve can be kept open and that the tyre can deflate slowly. It is made of a steel ball (18) which cooperates with the seat (17) and which is defined by a ring (1) which is inserted into the tubular element (12). The magnetic field is produced with the aid of a magnetized element (22) disposed in the vicinity of the membrane (6).

The technical scope of the present invention is that of valves to inflate a vehicle's tyres and inflation and deflation systems integrating such a valve.

Numerous documents describe inflation and deflation valves for tyres. By way of example, we quote patents EP-296017, EP-0246953 and FR-2731655. The latter more particularly describes a remotely controlled inflation and deflation system for a tyre adapted to light vehicles whose tyre pressure is of around 2 bars. However, the slow deflation of the tyre, which may be necessary in certain travel conditions, is not provided for.

The aim of the present invention is to supply a valve allowing a slow deflation of the tyre.

The invention thus relates to a wheel valve for a vehicle's tyre of the type incorporating a non-return valve, two half-bodies together delimiting a cavity and assembled with a membrane placed between them to ensure sealing for said half-bodies, the non-return valve being constituted by a tubular element integral with the membrane inside which the closing element is able to move between a seat and a base, said closing element being applied against the seat by the pressure in the tyre, wherein the closing element is subjected to the action of a magnetic field ensuring it is held at the base so as to hold said valve open and ensure the slow deflation of the tyre.

According to one characteristic of the invention, the closing element is a steel ball co-operating with the seat delimited by a ring inserted into the tubular element.

According to another characteristic of the invention, the magnetic field is produced using a magnetised element placed near to the membrane.

According to another characteristic of the invention, the magnetised element is in the form of a ring placed in a scallop in the ring.

According to another characteristic of the invention, a grid is placed between the ring and the base of the tubular element so as to limit the ball's displacement.

The invention also relates to a remote control installation for the slow deflation of a wheel tyre including a valve, wherein it comprises a first electrovalve placed in the supply circuit of said valve and three electrovalves placed downstream of the first one.

Advantageously, the first electrovalve is three-way.

Advantageously, compressed air pressure is applied to the ball using the electrovalve so as to move it away from the seat thus making the tyre communicate with the external atmosphere via the electrovalve.

A first advantage of the valve according to the invention lies in the fact that the valve is retained at the magnet so long as the rate of air being evacuated remains low.

Another advantage lies in the manufacturing simplicity of the slow deflation system.

Other characteristics, particulars and advantages of the invention will become more apparent from the description given hereafter by way of illustration and in reference to the drawings, in which:

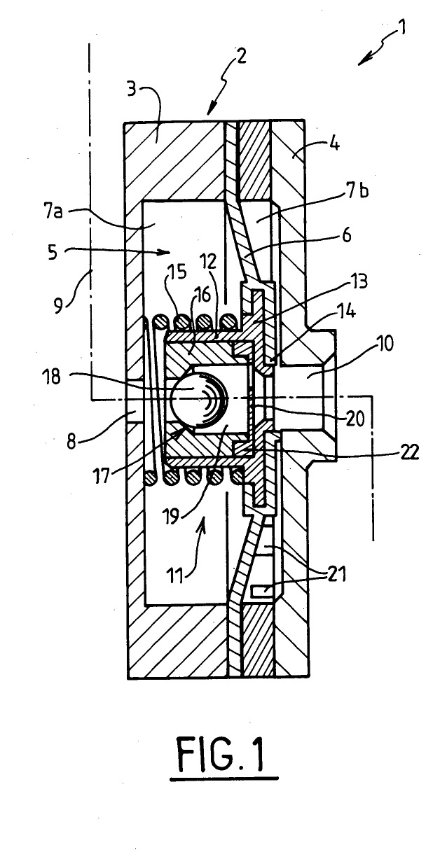

FIG. 1 is a diametral section of the valve according to the invention,

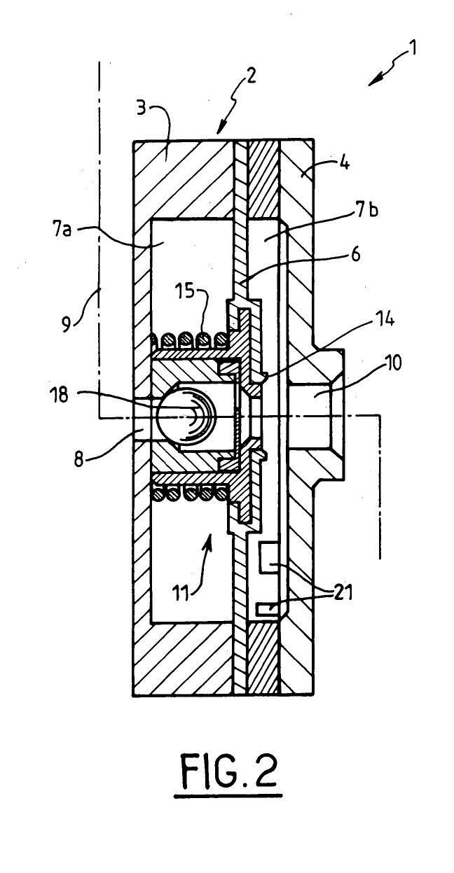

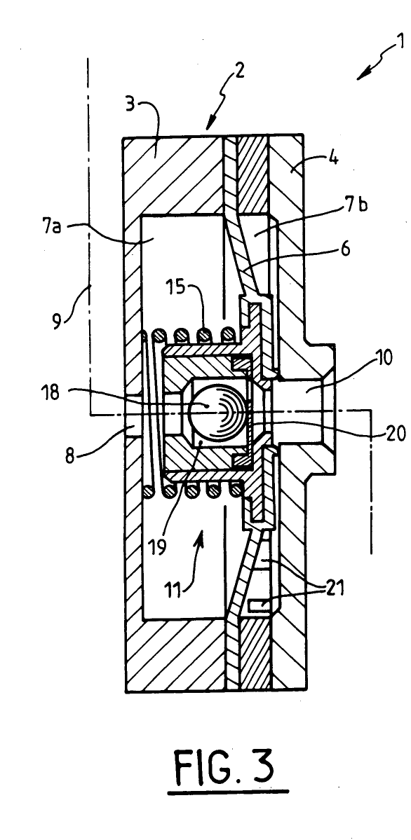

FIGS. 2 and 3 show two other operating positions of the valve, and

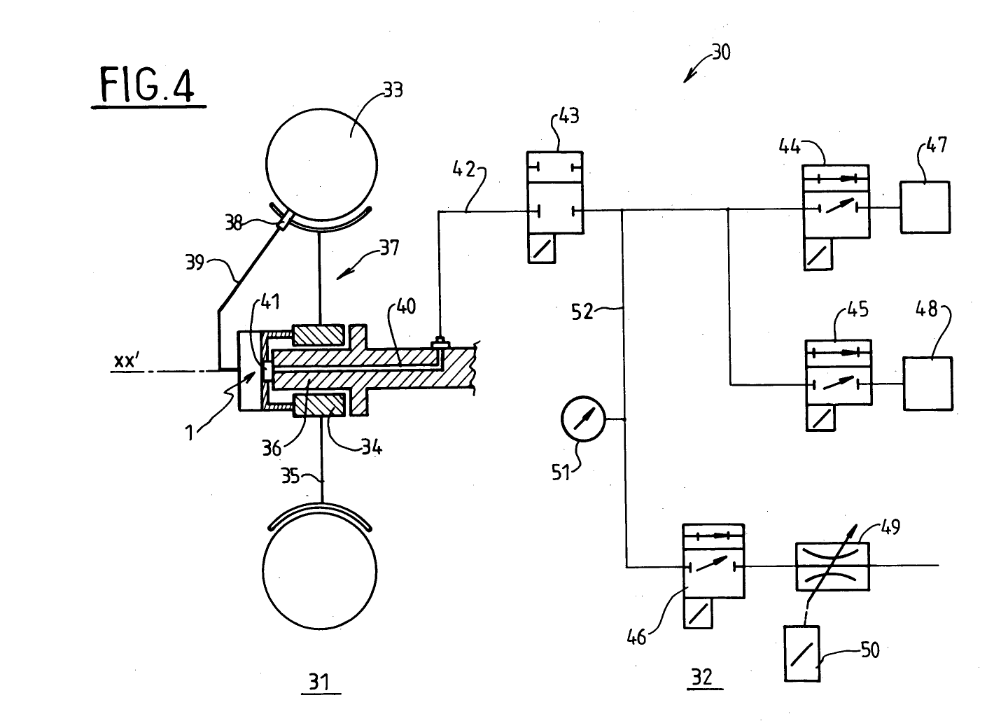

FIG. 4 shows one embodiment of the remote control installation.

FIG. 1 shows a section view of a valve 1 constituted by a body 2 composed of two half-bodies 3 and 4, made of a suitable material, assembled so as to be dismountable or not, face to face, and machined to make them delimit a cavity 5. Between them and by means of their peripheral edges, the half-bodies 3 and 4 pinch a membrane 6 that is elastically deformable and which divides the cavity into two chambers 7a and 7b. Half-body 3 has a connector 8 opening into chamber 7a and intended to be linked to line 9 of the servo-control circuit described more fully in reference to FIG. 4. Half-body 4 advantageously has a bore 10 in its central part that opens into chamber 7b and is intended to be connected by any suitable means to a supply channel for the vehicle wheel. The membrane 6 is associated with a servo-valve 11 constituted by a tubular element 12 connected to a base 13 whose peripheral crown is integrated into the membrane 6 that delimits a flange 14 or annular seal intended to surround the orifice of the bore 10 so as to insulate it from chamber 7b. In the Figure, we see that the flange 14 is formed directly by the membrane 6. The tubular element 12 is subjected to the action of a helicoidal spring 15 pressing on the base 13 and on the inner wall of half-body 3. The tubular element 12 further integrates a sheath 16 delimiting a seat 17 onto which a ball 18 presses so as to close off chamber 19 delimited by the sheath 16 in communication with the bore 10. The displacement of the ball 18 is limited by a grid 20 pinched between the base 13 and the sheath 16.

The purpose of the spring 15 is to constantly push the membrane 6 towards half-body 4 and hold the flange 14 against this half-body thereby insulating the bore 10 from chamber 7b that communicates with the external atmosphere via exhaust slots 21.

The sheath 16 is provided at the base 13 with a scallop in which a magnetised element 22 is inserted. The ball 18 constituting a closing element for chamber 19 is subjected to the action of a magnetic field when it is at the grid 20 ensuring its holding at the base 13 so as to hold said valve open and ensure the slow deflation of the tyre as will be explained hereafter. The force of the magnet 22 is calculated such as to counteract at least the weight of the ball 18 and the resultant of the aerodynamic forces exerted by the flow of air through chamber 19.

In the configuration shown in FIG. 1, the valve 1 is not being acted upon by the inflation and deflation system. The tyre is assumed inflated and the pressure holds the valve 11 closed via the ball 18 being pressed constantly against the seat 17 to insulate chamber 7a. Furthermore, the spring 15 holds the flange 14 constantly against half-body 4 and thereby closes chamber 7b.

Deflating the tyre in communication with the bore 10 is ensured in two different ways. FIG. 2 shows the position of the fast deflation valve 1 such as described in the afore-mentioned French patent. To this end, in a known manner, the pressure in chamber 7a is lowered so that it acts antagonistically to the spring 15 and brings the membrane 6 back into the position shown. The flange 14 is thus no longer pressing against half-body 4 and communication is established between the bore 10 and the exhaust slots 21 so as to rapidly evacuate outwards the pressurised fluid of the tyre.

FIG. 3 shows the position of the slow deflation valve 1 of the tyre. This possibility is important for the driver since a rapid deflation may jeopardise the handling of this vehicle. The starting position is considered the one shown in FIG. 1 and a brief intake of compressed air is controlled via the connector 8. This results in the ball 18 being pushed against the grid 20, which is then held in place thanks to the magnetic field generated by the magnet 22. The tyre is then made to communicate via the connector 8 through chamber 19 with the channel 9. Thus, a calibrated outlet of air is evacuated from the tyre without the ball 18 held in place by the magnet 22 being displaced.

The valve 1 thus produced may be integrated in a remotely controlled installation for a tyre or tyres as shown in FIG. 4. In this Figure, an installation 30 is shown constituted by an assembly 31 for each of the wheels 33 of a vehicle, not shown, and an assembly 32 at the driver's cab, the vehicle body or any other suitable place. Each wheel 33 is suitably fastened to a hub 34 by means of a wheel rim 35. The hub 34 is conventionally connected to one of the vehicle's axles 36. The valve 1 is suitably fastened to the wheel 37 by means of a revolving joint 41 and is connected to a valve 38 of the tyre 33 thanks to piping 39. As shown in the Figure, the valve 1 is assembled close to the axis xx′ of the wheel axle 36. This axle 36 is pierced by piping 40 to make the assembly 32 communicate with the valve 1 by means of a pipe 42. Assembly 32 is constituted by four electrovalves 43, 44, 45 and 46.

Electrovalve 43 is a three-way electrovalve that is positioned upstream of the three other electrovalves. It ensures the opening and closing of the piping 42 towards the valve 1. It also has an open air restoration function using the third way shown. Thus, the electrovalve 4 merely has to be duplicated to a number equal to that of the wheels.

Electrovalve 44 is linked to a source of compressed air 47 allowing the wheel 33 to be supplied with compressed air.

Electrovalve 45 is linked to a depression source 48 to lower the pressure of the valve 1.

Electrovalve 46 is linked to a choke mechanism 49 for the piping controlled by a coil 50 to control an air flow, which varies according to the number of electrovalves 43, towards the wheels 33.

The general operation of this system is identical to that of the system described in the afore-mentioned French patent with respect to the inflation and deflation of the wheels. However, the slow deflation function is ensured as follows. A pulsation of compressed air is sent using electrovalve 44, by opening and closing it rapidly, towards the valve 1, thereby dislodging the ball 18 from its seat. The ball thereafter takes up the position shown in FIG. 3, that is near to the grid 20. The tyre of the wheel 33 is thus made to communicate with chamber 19, then with the connector 8, then with the piping 40, then with the piping 42 and electrovalve 46, electrovalve 43 being open and electrovalves 44 and 45 being closed. When deflation has reached the required level, electrovalve 43 is closed and the ball goes back to its starting position shown in FIG. 1.

Fast deflation is ensured by controlling the opening of electrovalve 45 which, by the low pressure applied in chamber 7a, compresses the spring 15 and makes the tyre communicate with chamber 7b and the exhaust slots 21 with the external atmosphere.

The installation according to the invention also allows the easy checking of the inflation pressure by means of a manometer 51 connected to the piping 52 connecting electrovalves 43 and 46. The ball 18 is dislodged as explained previously and electrovalve 43 is left open and electrovalve 46 left closed. After the pressure has stabilised the measurement is made. After reading, electrovalve 43 is opened to close the valve 1 by causing the displacement of the ball and its application against the seat.

1. A wheel valve (1) for a vehicle's tyre of the type incorporating a non-return valve (11), two half-bodies (3, 4) together delimiting a cavity (5) and assembled with a membrane (6) placed between them to ensure sealing for said half-bodies, the non-return valve being constituted by a tubular element (12) integral with the membrane inside which the closing element (18) is able to move between a seat (17) and a base (20), said closing element being applied against the seat by the pressure in the tyre, wherein the closing element (18) is subjected to the action of a magnetic field ensuring it is held at the base (20) so as to hold said valve open and ensure the slow deflation of the tyre.

2. A wheel valve (1) according to claim 1, wherein the closing element is a steel ball (18) co-operating with the seat (17) delimited by a ring (16) inserted into the tubular element (12).

3. A wheel valve (1) according to claim 2, wherein the magnetic field is produced using a magnetised element (22) placed near to the membrane (6).

4. A wheel valve (1) according to claim 3, wherein the magnetised element (22) is in the form of a ring placed in a scallop in the ring (16).

5. A wheel valve (1) according to claim 4, wherein a grid (20) is placed between the ring (16) and the base (13) of the tubular element (12) so as to limit the ball's displacement.

6. A remote control installation (30) for the slow deflation of a wheel tyre including a valve (1) according to claim 1, wherein it comprises a first electrovalve (43) placed in the supply circuit of said valve and three electrovalves (44, 45, 46) placed downstream of the first one.

7. A remote control installation according to claim 6, wherein the first electrovalve (43) is three-way.

8. A remote control installation according to claim 7, wherein compressed air pressure is applied to the ball (18) using the electrovalve (45) so as to move it away from the seat (17) thus making the tyre communicate with the external atmosphere via the electrovalve (46).
